(19) United States
(12) Patent Application Publication
(10) Pub. No.: US 2006/0096480 A1
(43) Pub. Date: May 11, 2006

(54) Device for heat-treating a coating of flat-bed offset printing plates

(75) Inventor: Peter Hanosek, Kampfelbach (DE)

Correspondence Address: Orum & Roth LLC, Ste 1616, 53 W Jackson Blvd, Chicago, IL, 60604-3750, US

(73) Assignee: Techno-Graphica GmbH

(21) Appl. No.: 11/233,211

(22) Filed: Sep. 21, 2005

(30) Foreign Application Priority Data
Sep. 25, 2004 (DE) 20 2004 014 949.4

(51) Int. Cl. B41F 23/04

(52) U.S. Cl. 101/416.1

(57) ABSTRACT

The present invention provides a device for heat-treating a coating of flat-bed offset printing plates by application of hot air upon the flat-bed offset printing plates, comprises an upper hot-air chamber: a lower hot-air chamber, arranged at a distance from the upper hot-air chamber below the latter; an air-permeable endless conveyer belt having a carrying run, which extends between the upper and the lower hot-air chambers; a first air diffuser provided on the bottom of the upper hot-air chamber, and a second air diffuser provided on the top of the lower hot-air chamber. The two air diffusers are provided with air outlet openings that face the conveyer belt and at least one air inlet opening which is connected with the intake side of one or more blowers. The space between the two hot-air chambers, except for an entry opening for the carrying run and an exit opening for the carrying run for the conveyer belt, is closed.

### BACKGROUND OF THE INVENTION

1. Field of the Invention

The present invention relates to a device for heat-treating the exposed or non-exposed coating of flat-bed offset printing plates in a continuous process.

2. Description of Related Art

Flat-bed offset printing plates comprise a light-sensitive coating, based for example on a diazo layer, which is structured according to the image to be printed by an exposure process. The coating is carried on a metal plate, typically 0.15 mm to 0.5 mm thick, which in most cases consists of aluminum, in rare cases also of another metal or a metal alloy, for example a hard copper-chromium alloy. Once exposed, the flat-bed offset printing plate is developed by a wet-chemical process, is washed, dried and heat-treated to increase the hardness of the developed coating. The heat-treating process is also described as heat-fusing process and may be carried out also prior to the exposing operation.

The service life of a flat-bed offset printing plate, i.e. the number of prints that can be produced by it, depends on the hardness of the coating. For hardening the coating, it has been known to apply heat on the flat-bed offset printing plates from above by means of radiators or hot air, during which process temperatures of up-to-300° Celsius can be reached on the flat-bed offset printing plate, depending on the kind of the coating.

Heat-treating exposed or non-exposed flat-bed offset printing plates is connected with two significant problems:

In the first place, the coating will not harden uniformly. Upon completion of the heat-treatment, the coating does not show the same hardness in all areas of the flat-bed offset printing plate. However, the service life of the flat-bed offset printing plate is determined by the point of lowest hardness. In order to achieve the longest possible service life it is, therefore, desirable to achieve the same hardness in all areas of the flat-bed offset printing plate, if possible.

On the other hand, it has been found that as a result of the heat-treating process flat-bed offset printing plates tend to become uneven, which tendency becomes the more pronounced as the size and thickness of the flat-bed offset printing plates decrease. It has been observed that the unevenness may reach a value of up to 4 cm. Such unevenness hinders the operation of mounting the printing plate on the printing cylinder.

The flat-bed offset printing plate can be straightened, and its unevenness can be largely corrected, during the process of mounting it on a printing cylinder, but this is a difficult operation. Especially disadvantageous effects are produced by such unevenness on modern rotary offset presses which are equipped with automatic infeed means for the flat-bed offset printing plates. The flat-bed offset printing plates are placed for this purpose in a magazine from which the rotary offset press picks up the particular printing plate needed at any time for mounting it on the press roller. The press roller is provided for this purpose with narrow feed-in and retaining slots, adapted to the thickness of the flat-bed offset printing plate, in which the flat-bed offset printing plate must be fitted. However, an uneven flat-bed offset printing plate lends itself to automatic feeding either not at all or only with difficulty. In case of trouble, it is practically impossible to intervene manually in a rotary offset press with automatic infeed unit. In case the flat-bed offset printing plate gets stuck during the infeed process, before it is correctly mounted, the printing plate or, even worse, the press roller may be destroyed.

Modern rotary offset presses are extremely expensive so that everything is done to keep downtimes as short as possible. If possible, the presses should be kept running in three-shift operation without interruption. It is, therefore, of great interest to prevent, if possible, any unevenness in flat-bed offset printing plates.

### SUMMARY OF THE INVENTION

Now, it is the object of the present invention to open up a way for achieving coatings that are hardened more uniformly, and flat-bed offset printing plates that are less uneven.

This object is achieved by a device having the features defined in claim 1. Advantageous further developments of the invention are the subject-matter of the sub-claims.

The device according to the invention comprises an upper hot-air chamber and a lower hot-air chamber arranged at a distance below the upper hot-air chamber. Arranged in the space between the two hot-air chambers is the carrying run of an air-permeable endless conveyer belt, which extends between the two hot-air chambers and serves to convey the flat-bed offset printing plates through the space between the two hot-air chambers. Except for an entry opening and an exit opening for the carrying run of the conveyer belt, the space between the two hot-air chambers is closed toward the outside. A first air diffuser is provided on the bottom of the upper hot-air chamber. A second air diffuser is provided on the top of the lower hot-air chamber. The two air diffusers are provided with a plurality of air outlet openings that face the conveyer belt and at least one inlet opening which is connected with the intake side of one or more blowers. The invention provides substantial advantages:

By having the hot air act on both sides, the printing plate is heated up more rapidly and more uniformly.

The air diffusers, associated to the upper hot-air chamber and the lower hot-air chamber, are designed to distribute the air through their air outlet openings in such a way that uniform heating-up of the printing plate is achieved.

Structural differences in heat conductivity of the flat-bed offset printing plate have a less detrimental effect on the uniformity of the heating-up process.

The more uniform rise in temperature of the flat-bed offset printing plate reduces its tendency to warp.

It has been found that the temperature can be selected to be 200 Celsius to 300 Celsius lower than in prior art, without any loss in hardness. This not only reduces the tendency of the flat-bed offset printing plate to become uneven, but also reduces potential temperature gradients, thereby achieving more uniform hardening of the exposed coating.

Heating-up and hardening of the printing plates and their coatings is effected more rapidly, though without any risk of local overheating.

When heating-up and hardening is effected more rapidly, the throughput of the device can be increased. In the case of a practically realized example of a machine, the speed of the conveyor belt could be increased from 60 cm per minute to 110 cm per minute. This is a particular advantage as the heat-fusing device can thus be connected to a modern high-speed exposure machine without any problem.

The conveyer belt may be returned from its exit opening to its entry opening in the conventional way outside the device. The return movement may take place in a hot section of the device. It is, however, easier and of greater advantage, regarding the uniformity with which the flat-bed offset printing plates are heated up, if the conveyer belt is returned open through ambient air, below the hot-air chamber so that it may cool down on its way back to the entry opening.

The material of the conveyer belt is of course selected to withstand the temperatures encountered and the tensile forces. It is, however, an important aspect that the re-circulated hot air should be allowed to pass through the conveyer belt and should be hindered to the least possible degree. Preferably, the conveyer belt consists of an open-meshed wire mesh or a metal-ring mesh made from metal or a metal alloy having a thermal conductivity as low as possible, in any case substantially lower than that of copper or aluminum. This is to avoid as far as possible any temperature peaks at the points of contact between the flat-bed offset printing plate and the conveyer belt. This effect is supported by the open-meshed structure of the conveyer belt which makes it easy for the hot air to flow through the conveyer belt in all directions.

The air diffusers, which are to limit the upper hot-air chamber toward the bottom and the lower hotair chamber toward the top, are intended to ensure that the hot air will be distributed uniformly over the flat-bed offset printing plates as the latter are moved through the device. Preferably, the air outlet openings of the air diffusers extend for this purpose over the full width of the conveyer belt. This does not mean, however, that the air outlet openings necessarily must have the form of slots extending without interruption over the full width of the conveyer belt. Instead, the openings may be configured as separate slots or circular or oblong holes arranged in a row so that they extend substantially over the full width of the passage through which the printing plates pass the device. “Substantially” means in this context that the width over which the air outlet openings extend is sufficiently large to achieve the desired uniform heating and hardening effect for the exposed coating. Preferably, several such rows of air outlet openings are arranged one behind the other in the conveying direction, preferably in the form of slots extending transversely, especially at a right angle, to the conveying direction of the conveyer belt.

It is sought to achieve the desired uniform heating-up of the printing plates already by proper selection of the arrangement of the air outlet openings in the air diffuser. In order to be able to readjust the spatial distribution of the hot air flows in the device in case irregularities should occur in the transmission of heat and the heating effect, the width of at least part of the air outlet openings is made adjustable. Adjustment may be carried out manually, although power-operated adjustment is likewise possible. Power-operated adjustment provides the advantage that the outflow of hot air can be controlled according to technical specifications, and can be adjusted, for example, along temperature profiles that can be selected for the entire length of passage through the heat-fusing device.

For adjusting the width of the air outlet openings, baffles are preferably provided. In the case of slot-shaped openings, the baffles may be configured as slides that can be displaced transversely to the slots whereby the effective width of the slots can be effectively varied.

Preferably, the different baffles, just as the slots, rather than extending over the full width of the conveyer belt, extend over part of the conveyer belt only in order to allow any irregularities in temperature distribution, that may occur across the width of the conveyer belt, to be reduced.

The hot air that leaves the air outlet openings of the hot-air chambers and impinges upon the printing plates must be returned. For this purpose, each hot-air chamber is provided with at least one air inlet opening. The latter may extend in the form of a slot over the full width of the conveyer belt and should be directly connected with the intake side of one or more blowers intended to re-circulate the hot air in the heat-fusing device. A baffle serving to adjust the air inlet openings is, preferably, not provided.

In order to bring about an air re-circulation effect, at least one blower must be provided on each of the two sides of the conveyer belt, conveniently behind the air diffuser in the respective hot-air chamber, and the respective air inlet opening should be positioned in close proximity in front of the intake side of the respective blower. The air drawn into the hot-air chamber is conveniently guided by the blowers past electric heaters, especially tubular heaters, being thus heated, and leaves the system again through the air outlet openings. In order to obtain defined flow conditions, the capacity of the blowers is, preferably, adjusted to the clear cross-sections of the air outlet openings so that a clearly notable dynamic pressure, which is equal in front of all air outlet openings, is encountered in the hot-air chambers on the delivery side of the blowers.

The air diffuser preferably consists of a plate in which the air inlet openings and the air outlet openings are formed. The air inlet openings are arranged, preferably, in the middle between the entry opening and the exit opening of the device for the conveyer belt, whereas the air outlet openings are arranged on both sides of the air inlet openings. As a result, the hot air acts upon the printing plates as a parallel flow over the first half of its way through the device, and as a counterflow over the second half of its way, which has been found to be favorable with respect to the desired uniform heating-up of the printing plates and hardening of their coating.

### BRIEF DESCRIPTION OF THE INVENTION

One embodiment of the invention is illustrated diagrammatically in the attached drawings in which:

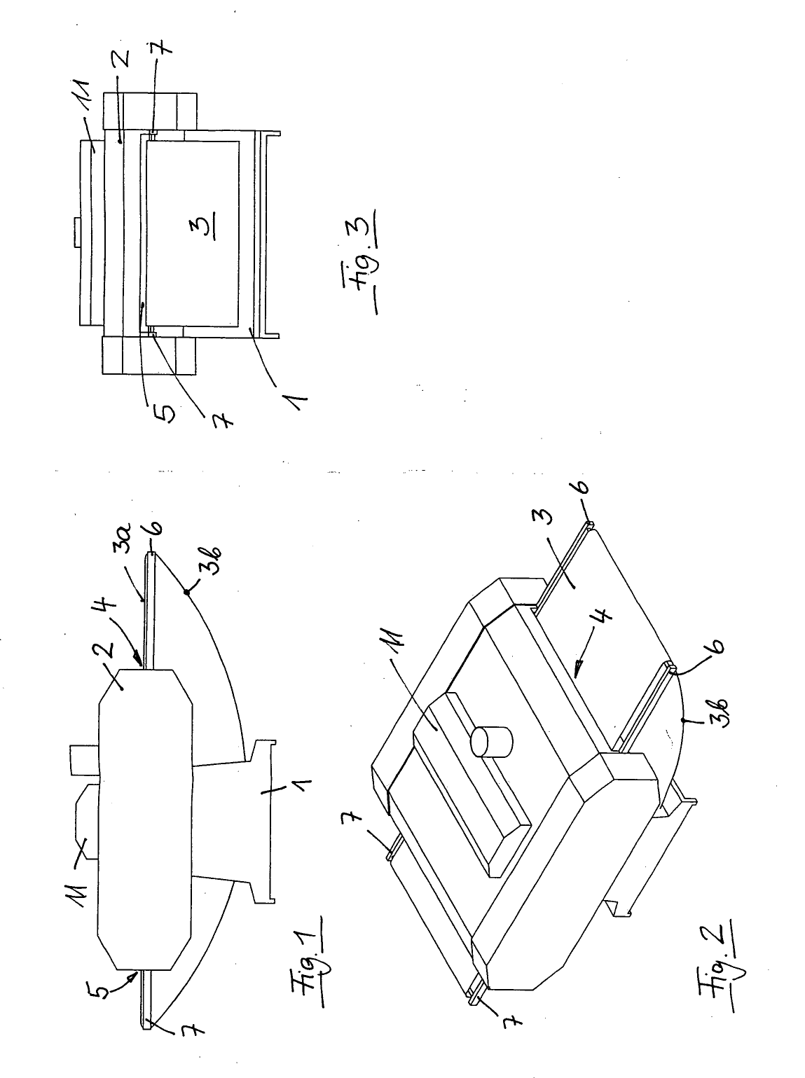

FIG. 1 shows a side view of a heat-fusing device;

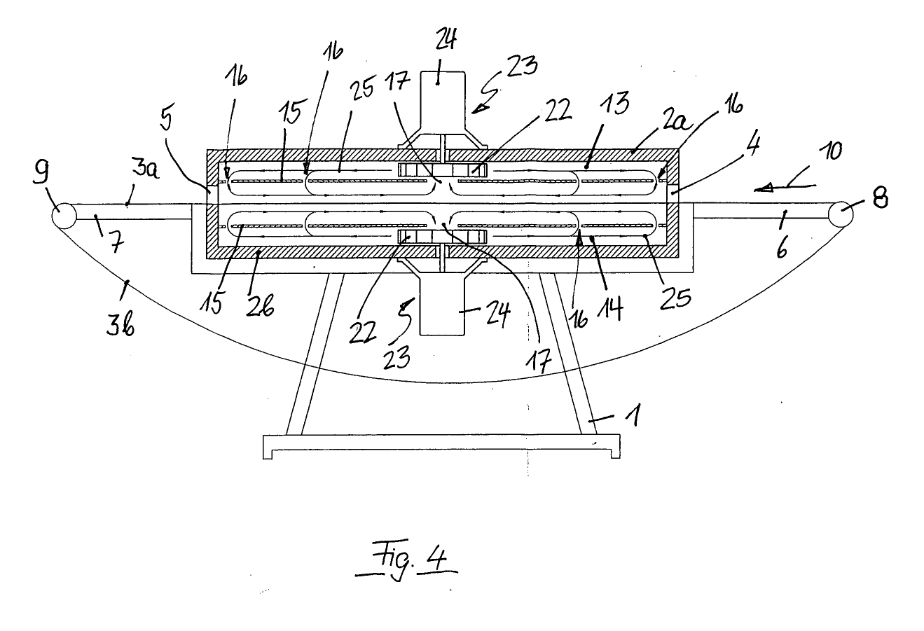

FIG. 2 shows an oblique view of the heat-fusing device;

FIG. 3 shows a rear view of the heat-fusing device;

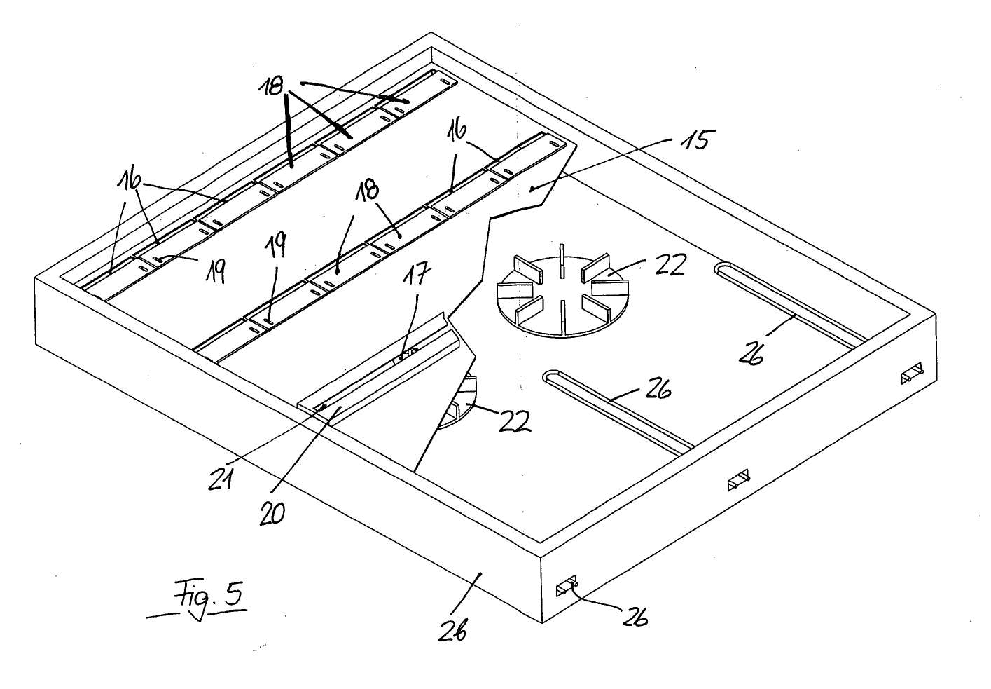

FIG. 4 shows a vertical lengthwise section through the heat-fusing device; and

FIG. 5 shows the lower hot air chamber as a detail, with part of the air diffuser being broken away.

### DETAILED DESCRIPTION OF THE INVENTION

The device, which is shown from the outside in FIGS. 1 to 3, comprises a housing 2, arranged on a frame 1, which is passed by an endless conveyer belt 3. The housing is provided with a horizontal slot-shaped entry opening 4, through which a conveyer belt 3 enters, and a horizontal slot-like exit opening 5 through which the conveyer belt 3 leaves the housing. Two arms 6, carrying a free-running guide roller 8, are attached in front of the entry opening 4. Two arms 7, carrying a driven guide roller 9, are attached in front of the exit opening 5, for drawing the carrying run 3a of the conveyer belt 3 through the housing 2 in tight condition, whereas the lower run 3b is guided back to the guide roller 8 in sagged condition.

The drive motors 24 of two blowers 12 are located below a hood 11 on the housing 2, see FIG. 4. The drive motors of two additional blowers, not shown in FIGS. 1 to 3, are located at the bottom of the housing 2.

The housing 2 comprises an upper hot-air chamber 13 and a lower hot-air chamber 14. The housing is formed for this purpose by an upper half shell 2a and a lower half shell 2b of rectangular outline. The two half shells 2a and 2b are open on their sides facing each other and are joined by those sides. In each of the two half shells 2a, 2b, at approximately half their height, there is arranged an air diffuser 15 consisting of a horizontal sheet-metal plate that extends over the full length and width of the respective half shell 2a, 2b. Both air diffusers 15 comprise a plurality of mutually parallel rows of air outlet openings 16 and two air inlet openings 17 arranged in the middle between the entry openings 4 and the exit opening 5 of the housing 2. The air outlet openings 16 are arranged on both sides of the air inlet openings 17. In the present case, the air outlet openings 16 are configured as four rows of slots which extend substantially over the full width of the half shells 2a and 2b and whose width can be individually adjusted by baffles 18. The baffles 18 consist of sheet-metal plates provided with oblong holes 19 by means of which they are screwed down on the air diffusers 15. After loosening the screws, the baffles 18 can be displaced in the conveying direction 10 or in a direction opposite to the conveying direction 10 and can be fixed again in their new position. The air inlet openings 17 are configured, for example, as circular bores opening, on the side of the air diffuser 15 that faces the conveyer belt 3, into a channel 20 which extends over the full width of the half shells 2a, 2b and which is provided with a slot 21, extending almost over the full width of the half shells 2a, 2b and facing the conveyer belt 3. The air inlet openings 17 are aligned with the rotary axes of rotors 22 of two radial blowers 12 whose drive motors 24 are arranged on the outside of the half shells 2a, 2b, respectively. The radial blowers 12 take in air from the space between the air diffuser 15 and the conveyer belt 3, through the air inlet openings 17, and return the air, after it has been heated up, through the slots 16 into the same space, as indicated by arrows 25 in FIG. 4. In this way, a constant exchange of air is achieved over the full length and width of the space between the two air diffusers 16, which exchange moreover can be finely adjusted as necessary by adjusting the baffles 19.

Arranged on both sides of the radial blowers 12, in the two hot-air chambers 13 and 14, are electric tubular heaters 26 for uniformly heating up the re-circulated air. In the area between the two air diffusers 15, the temperature and the temperature distribution may be monitored by electric temperature sensors, for example by thermal elements, the heat output of the tubular heater 26 may be correspondingly controlled, and the uniformity of the distribution of heat can be adjusted as required using the baffles 18.

The two half shells 2a, 2b, just as the air diffusers 15, preferably consist of bright stainless steel, which has proven its value for purposes of the invention, showing an only slight tendency to warp.

The flat-bed offset printing plates whose coatings are to be heat-fused are placed on the section 27 of the carrying run 3a of the conveyer belt 3, which is located in front of the entry opening 4, pass the heated inner space of the device where they are uniformly heated from both sides, and leave the housing 2 again through the exit opening 5.

1. Device for heat-treating a coating of flat-bed offset printing plates by application of hot air upon the flat-bed offset printing plates, comprising
an upper hot air chamber;
a lower hot-air chamber, arranged at a distance from the upper hot-air chamber below the latter;
an air-permissible endless conveyer belt having a carrying run which extends between the upper and the lower hot-air chambers;
a first air diffuser provided on the bottom of the upper hot-air chamber
a second air diffuser provided on the top of the lower hot-air chamber
the two air diffusers being provided with air outlet openings that face the conveyer belt and at least one air inlet opening which is connected with the intake side of one or more blowers;
and the space between the two hot-air chambers, except for an entry opening for the carrying run and an exit opening for the carrying run for the conveyer belt, being closed.

2. The device as defined in claim 1, characterized in that the entry opening and the exit opening are configured as slots.

3. The device as defined in claim 1, characterized in that the conveyer belt has a lower run which is returned below the lower hot-air chamber.

4. The device as defined in claim 3, characterized in that the lower run of the conveyer belt is returned open through ambient air.

5. The device as defined in claim 1, characterized in that the conveyer belt consists of a wire mesh or a metal-ring mesh.

6. The device as defined in claim 1, characterized in that the air outlet openings extend over the full width of the conveyer belt.

7. The device as defined in claim 1, characterized in that a plurality of air outlet openings (16) are arranged one behind the other in the conveying direction

8. The device as defined in claim 1, characterized in that the air outlet openings are configured as slots.

9. The device as defined in claim 1, characterized in that the slots extend transversely to the conveying direction.

10. The device as defined in claim 1, characterized in that the width of the air outlet openings is adjustable.

11. The device as defined in claim 10, characterized in that the width of the air outlet openings can be adjusted by power-operated means.

12. The device as defined in claim 10, characterized in that the width of the air outlet openings can be adjusted by means of baffles.

13. The device as defined in claim 12, characterized in that the individual baffles extend over a part, only, of the width of the conveyer belt.

14. The device as defined in claim 1, characterized in that the at least one air inlet opening extends over the full width of the conveyer belt or opens into a channel comprising a slot which extends over the full width of the conveyer belt and which faces the conveyer belt.

15. The device as defined in claim 1, characterized in that the air inlet openings and the air outlet openings are formed in a plate which limits the upper hot-air chamber toward the bottom and the lower hot-air chamber toward the top.

16. The device as defined in claim 1, characterized in that the air inlet openings are arranged in the middle between the entry opening and the exit opening of the conveyer belt and that the air outlet openings are provided on both sides of the air inlet opening.

17. The device as defined in claim 1, characterized in that the capacity of the blowers and the clear cross-section of the air outlet openings are tuned one relative to the other to ensure that the blowers produce a clearly notable dynamic pressure in the hot-air chambers in front of all air outlet openings.

18. The device as defined in claim 1, characterized in that one or more electric heating means are provided in each of the hot-air chambers that lie in the air flow of a blower.

19. The device as defined in claim 1, characterized in that the hot air chambers and the air diffusers by which they are closed, are made from bright stainless steel.

20. The device as defined in claim 2 characterized in that
the conveyer belt has a lower run which is returned below the lower hot-air chamber;
the lower run of the conveyer belt is returned open through ambient air;
the conveyer belt consists of a wire mesh or a metal-ring mesh;
the air outlet openings extend over the full width of the conveyer belt;
a plurality of air outlet openings are arranged one behind the other in the conveying direction;
the air outlet openings are configured as slots which extend transversely to the conveying direction;
the width of the air outlet openings is adjustable;
the at least one air inlet opening extends over the full width of the conveyer belt or opens into a channel comprising a slot which extends over the full width of the conveyer belt and which faces the conveyer belt;
the air inlet openings and the air outlet openings are formed in a plate which limits the upper hot-air chamber toward the bottom and the lower hot-air chamber toward the top;
the air inlet openings are arranged in the middle between the entry opening and the exit opening of the conveyer belt and that the air outlet openings are provided on both sides of the air inlet opening;
the capacity of the blowers and the clear cross-section of the air outlet openings are tuned one relative to the other to ensure that the blowers produce a clearly notable dynamic pressure in the hot-air chambers in front of all air outlet openings;
one or more electric heating means are provided in each of the hot-air chambers that lie in the air flow of a blower; and
the hot-air chambers and the air diffusers by which they are closed, are made from stainless steel.
